(19) United States
(12) Patent Application Publication
(10) Pub. No.: US 2007/0031592 A1
(43) Pub. Date: Feb. 8, 2007

(54) Static cling sign with multiple prints thereon

(76) Inventor: Ezra D. Eskandry, Aventura, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 11/195,091

(22) Filed: Aug. 2, 2005

(51) Int. Cl. B05D 5/00; B05D 1/36; B65B 33/00; C09D 5/00

(52) U.S. Cl. 427/154; 427/256; 427/284; 427/402

(57) ABSTRACT

The process for making a two sided, multiple print static cling sign includes providing a sheet like substrate of static cling material. One side is printed with a first color in a predetermined pattern and then is printed with a second color in a predetermined pattern. These predetermined patterns may or may not have void or open spaces. A border is printed delimiting the print on one side. Third and fourth colors are printed on the other side and each color has a predetermined pattern. A border is also printed on the other side delimiting the sign. The substrate is cut within the peripheral borders and a protective cover is removably attached to one of the side of the printed substrate.

The present invention relates to a process for making a two sided, multiple print static cling sign for a window and the resulting product.

### BACKGROUND OF THE INVENTION

Static cling signs are utilized in many applications but particularly are utilized in automobiles. The static cling sign generally includes a plastic substrate which, when placed against a glass window, removably attaches to the glass via a static cling characteristic established between the plastic and the window.

A problem has arisen in creating these static cling signs in that it is sometimes difficult to provide multiple colors on the static cling signs and to provide signage on both the front side, which is typically removably attached to the window, and the rear side, which is visible to the occupants of the building or automobile.

### OBJECTS OF THE INVENTION

It is an object of the present invention to provide a process for making a static cling sign wherein the sign is made with multiple prints.

It is another object of the present invention to provide a static cling sign with a border which reduces the required precision to register the predetermined print patterns on the front side and the rear side of the static cling substrate.

It is another object of the present invention to provide a static cling sign wherein the border delimits the sign periphery and a plurality of signs can be printed simultaneously on a single large substrate sheet and then the signs can be cut from that single large sheet based on cutting within the peripheral borders.

### SUMMARY OF THE INVENTION

The process for making a two sided, multiple print static cling sign includes providing a sheet like substrate of static cling material. One side is printed with a first color in a predetermined pattern and then is printed with a second color in a predetermined pattern. These predetermined patterns may or may not have void or open spaces. A border is printed delimiting the print on one side. Third and fourth colors are printed on the other side and each color has a predetermined pattern. A border is also printed on the other side delimiting the sign. The substrate is cut within the peripheral borders and a protective cover is removably attached to one of the side of the printed substrate.

### BRIEF DESCRIPTION OF THE DRAWINGS

Further objects and advantages can be found in the detailed description of the preferred embodiments when taken in conjunction with the accompanying drawings in which:

FIG. 1 diagrammatically illustrates the process of printing the two sided, static cling sign;

FIG. 2A diagrammatically illustrates registration of pattern 1 and 2 on one side of the substrate, particularly, the registration of the two patterns within the border and registration of two voids resulting in the base color from the opposing side being visible through the voids of the two patterns; and

FIG. 2B diagrammatically illustrates variable registration of the first and second pattern within the border field.

### DETAILED DESCRIPTION OF THE PREFERRED EMBODIMENTS

The present invention relates to a process for making a two sided, multiple print static cling sign and a sign made in accordance with the process.

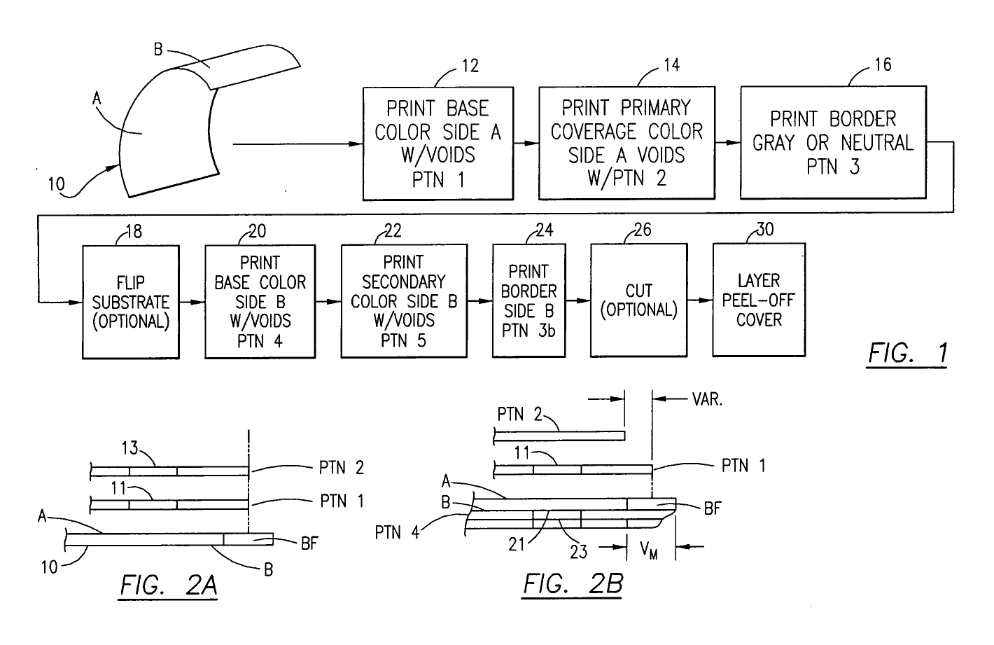

FIG. 1 diagrammatically illustrates the process in a preferred embodiment. A sheet like substrate of static cling plastic material 10 is provided. Substrate 10 includes side A and side B. Step 12 involves printing a base color on one of the sides, designated as side A. The print would utilize a first predetermined pattern Ptn 1 and that first pattern may or may not include voids or unprinted regions. The term “pattern” is abbreviated in the drawings as “Ptn.” Step 14 prints the primary coverage color on side A in pattern 2. Pattern 2 may or may not include voids or open spaces.

FIG. 2A shows substrate 1O having surface A with patterns 1 and 2. Void 11 in pattern 1 is in registration or aligned with void 13 of pattern 2. Therefore, the base color printed on side B of substrate 10 is visible through voids 11, 13 of patterns 1, 2. An observer looking a side A sees the base color on side B.

Returning to FIG. 1, step 16 prints a border delimiting the sign on the partially printed side A of substrate 10. Preferably, the border is gray or a neutral color. More precisely, the border is printed with a pattern 3. Pattern 3 is the border field BF. If substrate 10 is large enough to print multiple signs, multiple borders are printed on the substrate, each border defining a substantially closed area on the substrate within which area ultimately becomes the static cling sign. Step 18 involves flipping or turning the substrate over. Step 18 is optional in that certain printing processes could print the reverse side B of substrate 10 without flipping the substrate. Step 20 prints the base color on side B. This base color is printed via a pattern 4 which may or may not include voids. Step 22 prints a secondary color in pattern 5 on side B of substrate 10. Step 24 prints the border field BF on side B using pattern 3B. Pattern 3 and pattern 3B are substantially the same or are mirror images of each other. Step 26 involves cutting substrate 10 into a plurality of signs by cutting within the side border fields. Step 30 involves removably attaching a protective cover to the static cling side of the substrate 1O. During use, the operator removes the cover from the sign and that surface of the printed static cling sign removably adheres to the window such as an automobile window or a building window.

Since the static cling sign is printed on both sides, persons on either side of the window can see the sign. Further, since the base color is printed on both sides, there is substantially no visual interference between the printed sign on side A as compared with the printed sign on sign B. The substrate defines a two sided sign.

In one embodiment, a white base color was printed on side A and then a red primary coverage color was printed on side A over the white base cover. The voids in the primary red color on side A appear as “white print” since the white base cover color is presented to the user viewing side A. The base color utilized on side B was yellow. The base color on side B had a void or an open space in the color. Since the combination of red and white on side A results in a pink color, this pink color was visible on side B through the void in the yellow color base. If the first base pattern on side A has a void which is in registration with the void 21 in the base color of pattern 4 on side B and is also in registration with void 23 in the primary blue color of pattern 5 on side B (FIG. 2B), the primary red color in pattern 2 on side A is visible to the observer from side B. The red is visible through three voids.

FIG. 2B shows several features. One of the features is that there is a variable registration of the patterns. If pattern 1 is not in registration with pattern 2 as shown by variation Var. in FIG. 2B, the border BF hides the misrepresentation or mis-registration or variable registration VM. Also FIG. 2B shows that by placing voids 11, 21 and 23 in registration in patterns 1, 4 and 5, the observer on side B sees the primary red color printed on the sign as pattern 2.

The variable registration or the maximum variable registration Vm is based upon the size of the border field BF.

It should be noted that the printing of the static cling signs could be done in different stages rather than sequentially on a single side. Also, a plurality of signs could be printed on a single sheet and the sheet can be cut. Alternatively, the static cling sheet could be cut and then the base or border could be printed around the peripheral edge of the cut static cling sign. Thereafter, the colors and patterns 1, 2, 4 and 5 could be printed onto the static cling sign. Preferably, silk screen printing is utilized. More than two colors may be printed on each side.

The claims appended hereto are meant to cover modifications and changes within the scope and spirit of the present invention.

What is claimed is:

1. A process for making a two sided, multiple print static cling sign for a window comprising:
providing a sheet-like substrate of static cling plastic material, said substrate sheet having a top side and a bottom side;
printing a base first color on said top side with or without voids per a first predetermined pattern;
printing a second color on said top side with or without voids per a second predetermined pattern;
printing a top side border field delimiting a topside sign in conjunction with said first and second predetermined patterns, said border filed defining a substantially closed top side peripheral border;
printing a base third color on said bottom side with or without voids per a third predetermined pattern;
printing a fourth color on said bottom side with or without voids per a fourth predetermined pattern;
printing a bottom side border field delimiting a bottom side sign in conjunction with about said third and fourth predetermined patterns, said border filed defining a substantially closed bottom side peripheral border;
cutting said substrate within either of said top side or bottom side peripheral borders to form a two-sided static cling sign for said window;
providing and removably attaching a protective cover to either of said top side or said bottom side of the printed substrate.

2. A process for making a static cling sign as claimed in claim 1 wherein said printing is silk screen printing.

3. A process for making a static cling sign as claimed in claim 1 wherein said printed third and fourth colors have voids in registration and said base first color is visible through the registered voids.

4. A process for making a static cling sign as claimed in claim 1 wherein said top side and bottom side border fields permit variable registration of said first, second third and fourth patterns.

5. A two-sided, printed static cling sign according to the process of claim 1.

6. A process for making a static cling sign as claimed in claim 2 wherein said printed third and fourth colors have voids in registration and said base first color is visible through the registered voids.

7. A process for making a static cling sign as claimed in claim 6 wherein said top side and bottom side border fields permit variable registration of said first, second third and fourth patterns.

8. A two-sided, printed static cling sign according to the process of claim 7.

9. A process for making a two sided, multiple print static cling sign for a window comprising:
providing a sheet-like substrate of static cling plastic material, said substrate sheet having a top side and a bottom side;
printing a base first color on said top side with or without voids per a first predetermined pattern;
printing a second color on said top side with or without voids per a second predetermined pattern;
printing a top side delimiting border field in conjunction with said first and second predetermined patterns on said top side;
printing a base third color on said bottom side with or without voids per a third predetermined pattern;
printing a fourth color on said bottom side with or without voids per a fourth predetermined pattern;
printing a bottom side delimiting border field in conjunction with said third and fourth predetermined patterns on said bottom side;
cutting said substrate within one of said delimiting border fields to form a two-sided static cling sign for said window.

10. A process for making a static cling sign as claimed in claim 9 providing and removably attaching a protective cover to one of said top side or said bottom side of the printed substrate.

11. A process for making a static cling sign as claimed in claim 9 wherein said printing is silk screen printing.

12. A process for making a static cling sign as claimed in claim 9 wherein said printed third and fourth colors have voids in registration and said base first color is visible through the registered voids.

13. A process for making a static cling sign as claimed in claim 9 wherein said top side and bottom side border fields permit variable registration of said first, second third and fourth patterns.

14. A two-sided, printed static cling sign according to the process of claim 9.

15. A process for making a static cling sign as claimed in claim 10 wherein said printed third and fourth colors have voids in registration and said base first color is visible through the registered voids.

16. A process for making a static cling sign as claimed in claim 15 wherein said top side and bottom side border fields permit variable registration of said first, second third and fourth patterns.

17. A two-sided, printed static cling sign according to the process of claim 16.
